(19) United States
(12) Patent Application Publication
(10) Pub. No.: US 2024/0417980 A1
(43) Pub. Date: Dec. 19, 2024

(54) Vented Floor Tile

(71) Applicant: Aaron Hyden, Cleveland, TN (US)

(72) Inventor: Aaron Hyden, Cleveland, TN (US)

(21) Appl. No.: 18/741,939

(22) Filed: Jun. 13, 2024

Related U.S. Application Data
(60) Provisional application No. 63/507,971, filed on Jun. 13, 2023.

(51) Int. Cl. E04F 15/02; F21V 33/00

(52) U.S. Cl. CPC E04F 15/02005; E04F 15/02172; F21V 33/006

(57) ABSTRACT

A vented tile system includes a plurality of adjoining tiles, each tile including a solid surface area located across at least a portion of an upper surface of the tile. Each tile further includes a vented surface area located across at least a portion of the upper surface of the tile, the vented surface area including a plurality of slots formed therethrough. The solid surface area is located across the upper surface area such that the solid surface area is aligned with a solid surface area of an adjoining tile. Each tile may include a support structure beneath each solid surface area and may include a light portion that emits light through the vented surface area.

### REFERENCE TO RELATED APPLICATIONS

This application claims the priority of provisional patent application Ser. No. 63/507,971 filed Jun. 13, 2023 titled Vented Floor Tile.

### BACKGROUND OF THE INVENTION

This disclosure relates to the field of flooring and, more particularly, to a floor tile that allows for venting.

Floor tiles may be used to cover an existing floor surface to provide additional comfort, improve appearances, and to protect the existing floor surface. For example, floor tiles may be placed over a concrete surface to make the concrete surface more comfortable and to protect the concrete surface. Floor tiles are typically provided as a plurality of tiles that may be connected to one another to substantially cover a particular area of a floor.

Floor tiles are commonly provided as solid surface tiles, such as a solid surface featuring a pattern. Although some floor tiles may provide for small drainage holes, such holes do not typically allow for any fluid trapped underneath the floor tiles to evaporate or vent. Further, some tiles may be provided where a top surface of the tile is entirely comprised of slotted or vented portions for wet environments. However, such tiles do not provide any portion that is a solid surface on the tile to support a person or objects on the tile.

Therefore, it would be desirable to have vented floor tiles that allow for draining through the tile or venting from beneath the tile while further providing a solid surface area for supporting objects on top of the tile.

### SUMMARY OF THE INVENTION

Accordingly, a vented tile system includes a plurality of adjoining tiles, each tile including a solid surface area located across at least a portion of an upper surface of the tile. Each tile further includes a vented surface area located across at least a portion of the upper surface of the tile, the vented surface area including a plurality of slots formed therethrough. The solid surface area is located across the upper surface area such that the solid surface area is aligned with a solid surface area of an adjoining tile. Each tile may include a support structure beneath each solid surface area and may include a light portion that emits light through the vented surface area.

Therefore, a general object of this invention is to provide a vented tile system in which at least a portion of the upper surface includes a solid surface area that includes a vented surface area defining a plurality of slots formed therethrough.

Another object of this invention is to provide a vented tile system, as aforesaid, in which the solid surface area of the upper surface is aligned with a solid surface area of an adjoining tile.

Still another object of this invention is to provide a vented tile system, as aforesaid, in which the upper surface area includes ornamental indicia.

Yet another object of this invention is to provide a vented tile system, as aforesaid, that includes a lighting portion that emits light through the vented surface area.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a top view of a vented tile according to one aspect of the present disclosure;

FIG. 2 shows a bottom view of a vented tile according to one aspect of the present disclosure;

FIG. 3 shows a cross-sectional side view of a vented tile according to one aspect of the present disclosure;

FIG. 4 shows a perspective view of a floor constructed of a plurality of tiles according to one aspect of the present disclosure;

FIG. 5 shows a bottom perspective view of a tile according to one aspect of the present disclosure;

FIG. 6 shows a perspective view of a plurality of tiles according to one aspect of the present disclosure; and

FIG. 7 shows a bottom view of a tile according to one aspect of the present disclosure.

### DESCRIPTION OF THE PREFERRED EMBODIMENT

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

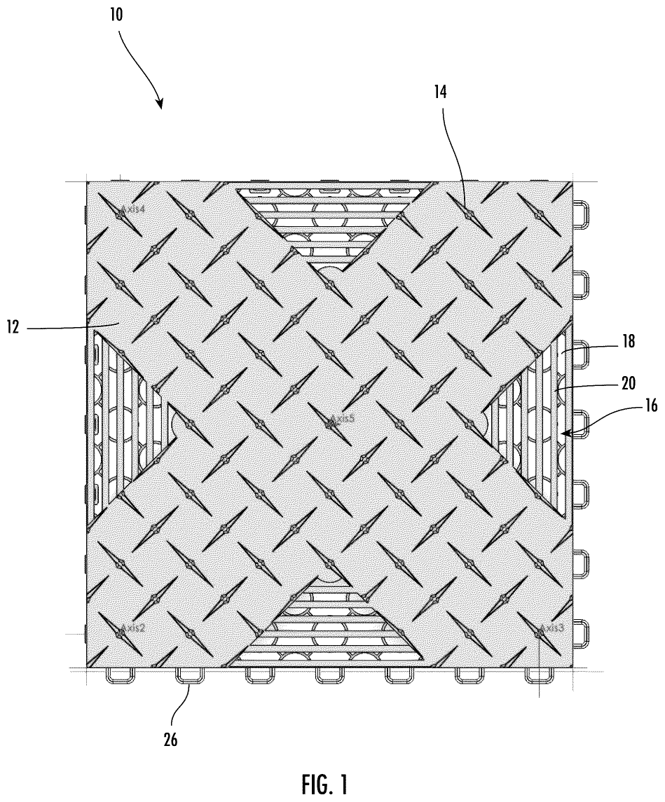

FIG. 1 shows a top view of a tile 10 according to one aspect of the present disclosure. The tile 10 may be referred to as having a tile substrate which includes various predetermined portions and exhibits predetermined characteristics. More particularly, the tile substrate refers to a hard-wearing material, such as ceramic, stone, metal, baked clay, or glass, that is used to cover roofs, floors, walls, edges, or other objects. Tiles are usually thin and square or rectangular in shape. They are often made from a mixture of water, sand, and clay, and the spaces between them, called grout, are filled with a separate mixture of water, sand, and cement. In the present instance, the tile 10 is adapted to include a solid surface area portion and a vented portion located through an upper surface of the tile 10 to allow venting from beneath the tile 10 while also providing a stable surface for supporting objects thereon. The tile 10 is adapted to be connected to adjoining tiles to cover a desired floor surface. The tile 10 may be suitable for covering other desired surfaces, such as a wall surface. The tile 10 advantageously allows for venting through the tile 10 while also providing a substantially solid and stable surface. Further, the solid surface area portions and vented portions may be arranged on the tile 10 to create a pattern when the tile 10 is joined with adjacent tiles on a floor surface. The tile 10 may be formed of a polymer, such as polypropylene, polyethylene, polyvinyl chloride, and other various suitable materials. The tile 10 may be formed of a material that is phosphorescent such that the tile 10 glows in the dark. In some implementations, the tile may include a material that has anti-static properties. In some implementations, the tile may include an additive that has anti-static properties. In some implementations, the additive having anti-static properties includes carbon.

Referring again to FIG. 1, the tile 10 includes a solid surface area 12 located on a top surface of the tile 10. The solid surface area 12 is located across a portion of the top surface of the tile 10. The solid surface area 12 may be substantially flat and may feature raised elements located on the solid surface area 12. For example, the solid surface area 12 may include a plurality of raised lugs 14 located on the solid surface area 12 to aid in traction on the tile 10, such as when the tile 10 becomes wet. In some implementations, the lugs are further located on at least a portion of the vented surface area and/or the solid surface area.

The solid surface area 12 may be formed in a desired shape on the top surface of the tile 10. The desired shape may be such that the solid surface area 12 creates a pattern when the tile 10 is joined with additional tiles as discussed in greater detail below. The solid surface area 12 of the tile 10 may be shaped such that the solid surface area 12 aligns with portions of the solid surface area 12 of an adjoining tile 10. For example, the solid surface area 12 may be formed as a cross or “X” shape across the top surface of the tile 10. The solid surface area 12 may be formed in other various suitable shapes, such as rectangular, circular, and other shapes on the tile 10. The solid surface area 12 may extend to corners or sides of the tile 10 and align with the solid surface area 12 at corners or sides of adjoining tiles.

With further reference to FIG. 1, the tile 10 further includes a vented surface area 16 located across a top surface of the tile 10. The vented surface area 16 is located across the top surface of the tile 10 at portions adjacent to the solid surface area 12. The solid surface area 12 and the vented surface area 16 together form the top surface of the tile 10. The solid surface area 12 may cover from about 30% to about 70% of a surface area of the top surface of the tile 10. In another implementation, the solid surface area 12 may cover more than 50% of the surface area of the top surface of the tile 10 relative to the vented surface area.

The vented surface area 16 may include a plurality of elongate strips 20 that define a plurality of slots 18 therebetween. The elongate strips 20 may extend between portions of the solid surface area 12 of the tile 10, or may extend between side edges of the tile 10 on the vented surface area 16. An upper surface of the elongate strips 20 may be coplanar with an upper surface of the solid surface area 12.

In one example, the vented surface area 16 may have a wedge-shaped or triangular configuration such that the vented surface area 16 fits between portions of a cross or “X” shaped portion of the solid surface area 12 as shown in FIG. 1. The vented surface area 16 may be formed into a variety of other suitable shapes such that the vented surface area 16 fits with the solid surface area 12. The vented surface area 16 may be shaped such that the vented surface area 16 aligns with the vented surface area 16 of adjoining tiles as discussed in greater detail below. For example, portions of the vented surface area 16 located along side edges of the tile 10 may align with portions of the vented surface area 16 located along side edges of adjoining tiles.

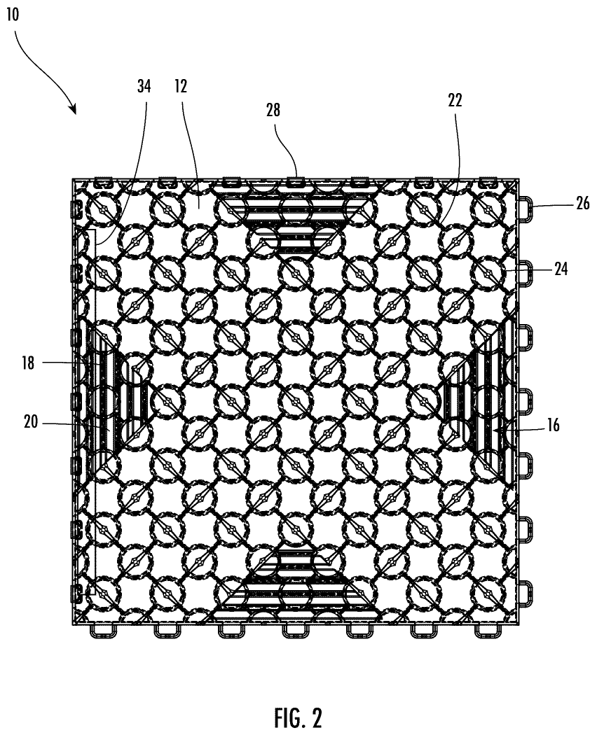

Referring now to FIG. 2, the tile 10 may include a plurality of support ribs 22 situated underneath the solid surface area 12 and the vented surface area 16 of the tile 10. The plurality of support ribs 22 may extend from a bottom surface of the solid surface area 12 and the vented surface area 16 to a bottom of the tile 10 such that the plurality of support ribs 22 may support the tile 10. The tile 10 may further include a plurality of supports 24 spaced-apart along an underside of the tile 10 for further supporting the tile 10. The plurality of supports 24 may be circular in shape, or may be shaped in other various suitable shapes. The support ribs 22 may extend between the supports 24 such that the supports 24 are substantially interconnected along an underside of the tile 10 to support the tile 10 and objects thereon.

Spacing of the slots 18 and the elongate strips 20 may be such that the slots 18 and the elongate strips 20 are spaced-apart on the plurality of supports 24 in an amount that is less than a spacing of the solid surface area 12 of the tile 10. For example, each of the slots 18 and the elongate strips 20 may be spaced-apart such that one of the slots 18 and one of the elongate strips 20 is positioned across a width of one of the plurality of supports 24. The solid surface area 12 may be arranged on the plurality of supports 24 such that multiple of the plurality of supports 24 are extended across a width of the solid surface area 12.

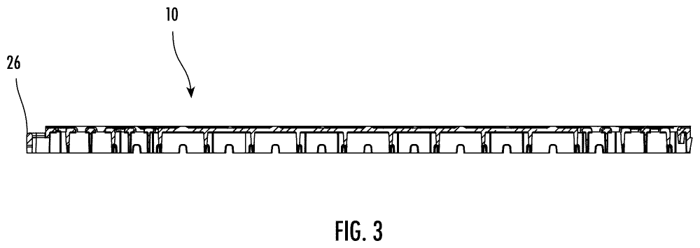

Referring to FIG. 3, the tile 10 may include an interlocking portion located on one or more sides of the tile 10 for securing the tile 10 to adjacent tiles. For example, the tile 10 may include a plurality of projections 26 extending from two or more sides of the tile (FIG. 2). The plurality of projections 26 may extend from multiple sides of the tile 10, such as from two sides of the tile 10 as shown in FIG. 2. The tile 10 may further include one or more receiving portions 28 that are shaped to receive the plurality of projections 26. In other words, the receiving portions 28 have configurations that are complementary to the projections 26, respectively. The tile 10 may be joined with adjoining tiles by aligning the plurality of projections 26 of a first tile with the plurality of receiving portions 28 of a second tile located adjacent to the first tile. The one or more receiving portions 28 may form a friction fit with the plurality of projections 26 to substantially secure the tiles to one another.

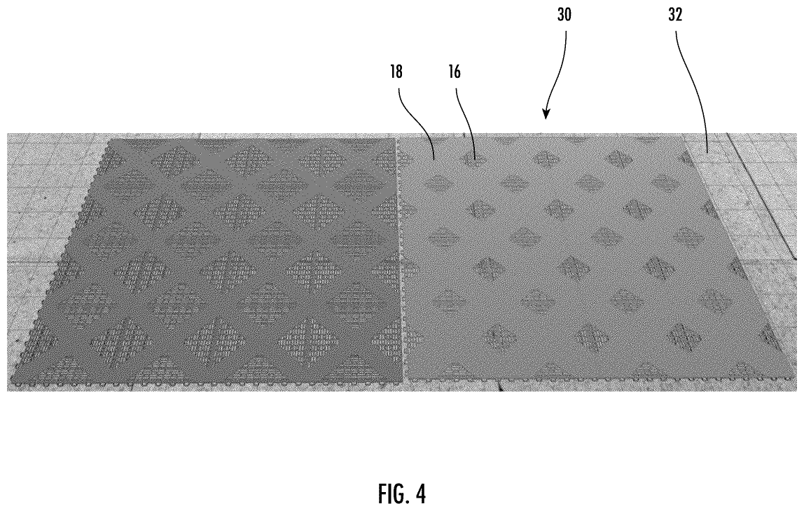

FIG. 4 illustrates a floor 30 formed of a plurality of the tiles 10 joined with one another to at least partially cover an underlying surface 32. The plurality of tiles is joined together as described above such that the solid surface area 12 and the vented surface area 16 of the tiles are substantially aligned with one another. The aligned solid surface area 12 and the vented surface area 16 of the joined tiles may create a pattern, such as creating diamond-shaped, square-shaped, or other various shapes of the vented surface area 16. Further, the aligned vented surface area 16 of the tiles allows for water to drain through the floor 30 while further allowing venting or drying of the underlying surface 32.

Referring again to FIG. 2, in one aspect the tile 10 may include a lighted portion 34 located underneath the tile 10. The lighted portion 34 may be located, for example, alongside edges of the tile 10 on an underside of the tile 10. The lighted portion 34 may include an LED light strip. The lighted portion 34 may be powered by a battery, or may include a connector such that the lighted portion 34 may be connected to the lighted portion 34 of adjacent tiles and subsequently connected to a power source. The lighted portion 34 is arranged on the tile such that when the lighted portion 34 is energized, light from the lighted portion 34 is reflected off of the underlying surface 32 and emitted through the vented surface area 16.

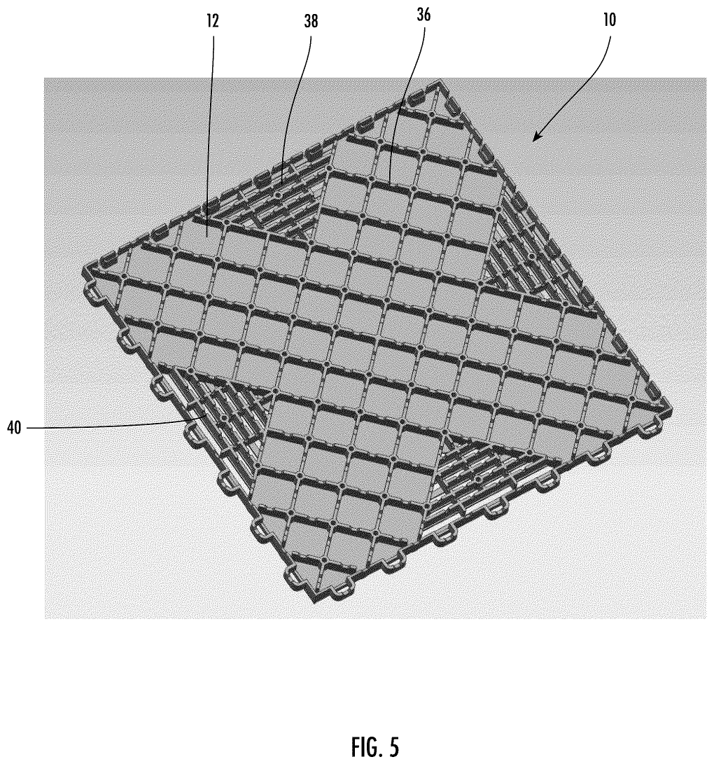

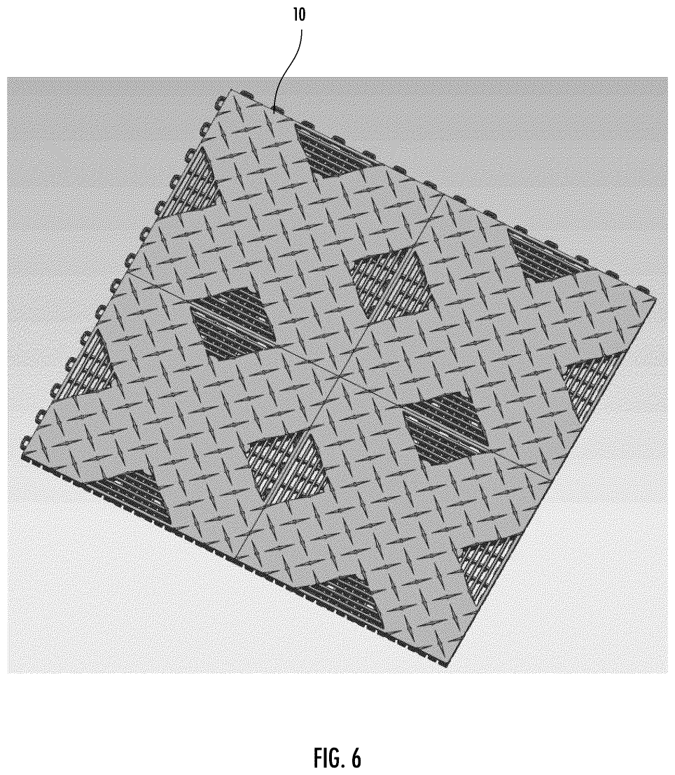

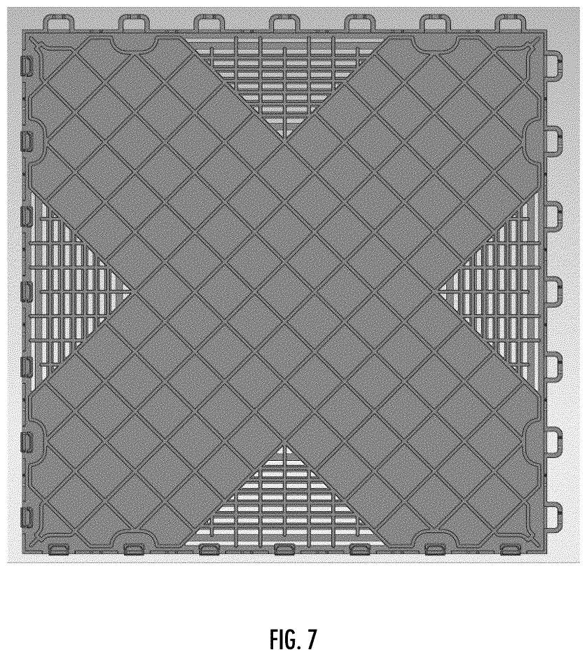

Additional aspects of the tile 10 are shown in FIG. 5, FIG. 6, and FIG. 7. As shown in FIG. 5, FIG. 6, and FIG. 7, a support structure of the tile 10 may include separate solid surface supports 36 located under the solid surface area 12. The solid surface supports 36 may form a grid beneath the solid surface area 12 and may be arranged such that the solid surface supports 36 are oriented parallel and perpendicular to the solid surface area 12. A support structure of the tile 10 may further include a plurality of strip supports 38. The plurality of strip supports 38 may be arranged under the plurality of elongate strips 20 such that the plurality of strip supports 38 are substantially parallel to the plurality of elongate strips 20. The slots 18 may be formed between the plurality of strip supports 38. The plurality of strip supports 38 may include one or more gaps 40 formed at a bottom edge of the plurality of strip supports 38 to aid in draining of fluids through the tile 10.

The tile 10 disclosed herein advantageously allows for draining of fluid through the floor 30 formed by a plurality of the tiles while further allowing for venting beneath the tile 10. Further, the solid surface area 12 on the tile 10 is positioned such that when a floor is constructed from a plurality of tiles, the solid surface area 12 may be aligned with the solid surface area of adjoining tiles to form a pattern or otherwise enhance an appearance of the floor. Further, the solid surface area 12 of the tile 10 may provide support for objects located on the tile 10.

The foregoing description of preferred embodiments of the present disclosure has been presented for purposes of illustration and description. The described preferred embodiments are not intended to be exhaustive or to limit the scope of the disclosure to the precise form(s) disclosed.

Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

It is understood that while certain forms of this invention have been illustrated and described, it is not limited thereto except insofar as such limitations are included in the following claims and allowable functional equivalents thereof.

1. A vented tile system, comprising
a plurality of adjoining tiles, each tile having an upper surface and a solid surface area situated across at least a portion of the upper surface; and
a vented surface located across at least a portion of the upper surface of the tile, said vented surface area including a plurality of strips defining a plurality of slots therebetween;
wherein said solid surface area is located across said upper surface such that said solid surface area is aligned with a solid surface area of a respective adjoining tile.

2. The vented tile system as in claim 1, wherein said solid surface area has a generally flat configuration and includes a plurality of raised lugs atop said solid surface area and configured to enhance traction atop said solid surface area.

3. The vented tile system as in claim 1, further comprising an interlocking portion having a configuration complementary to said interlocking portion of an adjacent tile.

4. The vented tile system as in claim 3, wherein said interlocking portion includes a plurality of projections and a plurality of receiving portions configured to receive said plurality of projections, respectively, of an adjacent interlocking portion in a friction fit manner.

5. The vented tile system as in claim 1, wherein:
said solid surface area and said vented surface together form a top surface of a respective tile; and
said solid surface area covers from about 30% to about 70% of a total surface area of the top surface of said respective tile.

6. The vented tile system as in claim 1, wherein:
said solid surface area and said vented surface together form a top surface of a respective tile; and
said solid surface area covers about 50% of a total surface area of the top surface of said respective tile.

7. The vented tile system as in claim 4, wherein said solid surface area may include a shape indicium such that corresponding solid surface areas of said plurality of adjoining tiles, when interlocked together, form a pattern.

8. The vented tile system as in claim 1, wherein said vented surface area has a wedge-shaped or triangular configuration that may be positioned adjacent a corresponding vented surface area of said respective adjoining tile.

9. The vented tile system as in claim 1, further comprising a lighted portion mounted to an underside of each tile, said lighted portion including an LED light strip that, when energized, reflects light off of said underside of said each tile and emits light through a respective vented surface area.

10. The vented tile system as in claim 1, further comprising a support structure mounted beneath said solid surface area of each said tile, respectively, said solid support structure including a plurality of solid surface supports extending parallel and perpendicular so as to form a grid beneath said solid surface area.

11. A vented tile system, comprising
a plurality of tiles, each tile having an upper surface and a solid surface area extending across at least a portion of the upper surface;
a support structure mounted beneath said solid surface area of each said tile, respectively, said solid support structure including a plurality of solid surface supports extending parallel and perpendicular so as to form a grid beneath said solid surface area;
a vented surface mounted atop at least a portion of the upper surface of the tile, said vented surface area including a plurality of strips defining a plurality of slots 9 therebetween;
said solid surface area and said vented surface together form a top surface of a respective tile.

12. The vented tile system as in claim 11, wherein each said tile includes at least one peripheral edge, said vented tile system further comprising an interlocking portion situated along said at least one peripheral edge and having a configuration complementary to said interlocking portion of an adjacent tile.

13. The vented tile system as in claim 12, wherein said interlocking portion includes a plurality of projections and a plurality of receiving portions configured to receive said plurality of projections, respectively, of an adjacent interlocking portion in a friction fit manner.

14. The vented tile system as in claim 11, wherein:
said solid surface area and said vented surface together form a top surface of a respective tile; and
said solid surface area covers from about 30% to about 70% of a total surface area of the top surface of said respective tile.

15. The vented tile system as in claim 11, wherein:
said solid surface area and said vented surface together form a top surface of a respective tile; and
said solid surface area covers about 50% of a total surface area of the top surface of said respective tile.

16. The vented tile system as in claim 11, wherein said solid surface area has a generally flat configuration and includes a plurality of raised lugs situated atop said solid surface area and configured to enhance traction atop said solid surface area.

17. The vented tile system as in claim 12, wherein said vented surface area has a wedge-shaped or triangular configuration that may be positioned adjacent a corresponding vented surface area of an interlocked tile.

18. The vented tile system as in claim 11, further comprising a lighted portion mounted to an underside of each tile, said lighted portion including an LED light strip that, when energized, reflects light off of said underside of said each tile and emits light through a respective vented surface area.

19. A vented tile system, comprising
a plurality of tiles, each tile having an upper surface and a solid surface area extending across at least a portion of the upper surface;
a support structure mounted beneath said solid surface area of each said tile, respectively, said solid support structure including a plurality of solid surface supports extending parallel and perpendicular to one another so as to form a grid beneath said solid surface area;
a vented surface mounted atop at least a portion of the upper surface of the tile, said vented surface area including a plurality of strips defining a plurality of slots therebetween;
a lighted portion mounted to an underside of each tile, said lighted portion including an LED light strip coupled to a battery and that, when energized, reflects light off of said underside of said each tile and emits light through a respective vented surface area; and
an interlocking portion mounted to a peripheral edge of said tile and having a configuration complementary to said interlocking portion of an adjacent tile;
wherein said interlocking portion includes a plurality of projections and a plurality of receiving portions configured to receive said plurality of projections, respectively, of an adjacent interlocking portion in a friction fit manner.

20. The vented tile system as in claim 19, wherein at least that solid surface area of said tile is constructed of a phosphorous material that glows in the dark.
